(19) United States
(12) Patent Application Publication
(10) Pub. No.: US 2013/0332236 A1
(43) Pub. Date: Dec. 12, 2013

(54) Optimizing Market Research Based on Mobile Respondent Behavior

(71) Applicant: Palanivel Kuppusamy, (US)

(72) Inventor: Palanivel Kuppusamy, (US)

(73) Assignee: Ipinion, Inc.

(21) Appl. No.: 13/492,170

(22) Filed: Jun. 8, 2012

(51) Int. Cl. G06Q 30/02

(52) U.S. Cl. 705/7.34; 705/7.29

(57) ABSTRACT

Systems and method for conducting meaningful market research on respondents using mobile devices. Data relating to mobile respondent behavior is leveraged to initiate more effective market research applications such as surveys. Using a mobile respondent's behavior, a market research enterprise initiates market research specifically related to that behavior. The market research applications may be transmitted to a mobile respondent using a number of different mechanisms such as push messages, text messages, SRS messages, emails, etc. Also, mobile respondents may download and install an application that allows them to quickly access the market research applications and transmit the market research data.

### CROSS-REFERENCE TO RELATED APPLICATIONS

This patent application is related to commonly assigned, co-pending U.S. patent application Ser. No. xx/xxxxxx, filed Jun. 8, 2012 and entitled “OPTIMIZING MARKET RESEARCH BASED ON MOBILE RESPONDENT LOCATION” (Attorney Docket: ERWP.P0010US), commonly assigned, co-pending U.S. patent application Ser. No. xx/xxxxxx, filed Jun. 8, 2012 and entitled “OPTIMIZING MOBILE USER DATA STORAGE” (Attorney Docket: ERWP.P0012US), and commonly assigned, co-pending U.S. patent application Ser. No. xx/xxxxxx, filed Jun. 8, 2012 and entitled “OPTIMIZING MARKET RESEARCH USING INDICIA-BASED MOBILE RESPONDENT DATA” (Attorney Docket: ERWP.P0013US) the disclosures of which are incorporated herein by reference in their entirety.

### TECHNICAL FIELD

This disclosure is generally directed to a system and method for optimizing mobile respondent market research. This disclosure is specifically directed to systems and methods for conducting market research considering mobile respondent behavior.

### BACKGROUND

Market research is an organized effort to gather information about markets or customers. Market research can include social and opinion research performed to systematically gather and interpret information about individuals or organizations using statistical and analytical methods and techniques of the applied social sciences to gain insight or support decision making. Viewed as an important component of business strategy, market research can be a key factor to obtain advantage over competitors. Market research provides important information to identify and analyze market need, market size, and competition.

The advent of mobile devices, such as smart phones, presents new opportunities for enlisting mobile device users as mobile respondents in performing market research.

### SUMMARY

According to an embodiment, methods and systems are provided for conducting mobile respondent market research. Behavioral data relating to a mobile respondent is received at a market research enterprise. In response, a market research application based on the behavioral data is transmitted to a mobile device associated with the mobile respondent.

According to another embodiment, other methods and systems are provided for conducting mobile respondent market research. Behavioral data relating to a mobile respondent is transmitted to a market research enterprise. In response, a market research application based on the behavioral data is received at a mobile device associated with the mobile respondent.

According to one embodiment, other methods and systems are provided for conducting mobile respondent market research. One or more mobile respondent behaviors of interest are identified for conducting market research. Also, instructions to initiate a market research application if a mobile respondent exhibits one or more of the identified behaviors are provided. Further, market research data relating to the market research application is received.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE FIGURES

For a more complete understanding of the present disclosure, reference is now made to the following descriptions taken in conjunction with the accompanying figures, in which:

FIG. 1 illustrates a network in which concepts described herein may be implemented;

FIG. 2 illustrates functional blocks executed to perform a method of mobile respondent market research according to the concepts described herein;

FIG. 3 illustrates functional blocks of components of an apparatus for mobile respondent market research according to the concepts described herein;

FIG. 4 illustrates system components for performing another method of mobile respondent market research according to the concepts described herein;

FIG. 5 illustrates functional blocks of components of another apparatus for mobile respondent market research according to the concepts described herein;

FIG. 6 illustrates functional blocks executed to perform another method of mobile respondent market research according to the concepts described herein; and

FIG. 7 illustrates functional blocks of components of another apparatus for mobile respondent market research according to the concepts described herein.

### DETAILED DESCRIPTION

Systems and methods described herein provide a mechanism for conducting meaningful market research on respondents using mobile devices. Data relating to mobile respondent behavior is leveraged to initiate more effective market research applications such as surveys and the like. Using a mobile respondent's location, a market research enterprise interested in focused market research may initiate market research that is specifically related to the respondent's behavior. The market research applications may be transmitted to mobile respondents by a number of different mechanisms such as push messages, text messages, SRS messages, emails, etc. Also, mobile respondents may download and install an application that allows them to quickly access the mobile research applications and transmit the market research data.

According to concepts described herein, collecting respondent behavioral data is useful to a market research enterprise in offering more relevant market research applications to a respondent. In many ways, such behavioral data is more helpful to a market research enterprise than feedback provided by a respondent in the form of answered questionnaires and the like. That is, feedback provided by a market research respondent is necessarily subjective and often not sufficiently accurate. For example, the feedback information may be inaccurate where the respondent is less than truthful, embarrassed, or does not fully understand the questions. Further, changes in feedback information will not be captured without effective use of periodic updates. The respondent will perhaps present a biased view of his/her activities, believing himself/herself to spend more time on one activity than he/she actually does while believing himself/herself to spend less time on another activity than he/she actually does. By capturing behavior data, a market research enterprise captures an objective view of the respondent's preferences, activities, experiences, etc. Equipped with an objective view of the respondents experiences, the market research enterprise is able to more accurately identify what market research is most relevant to a targeted respondent or set of respondents.

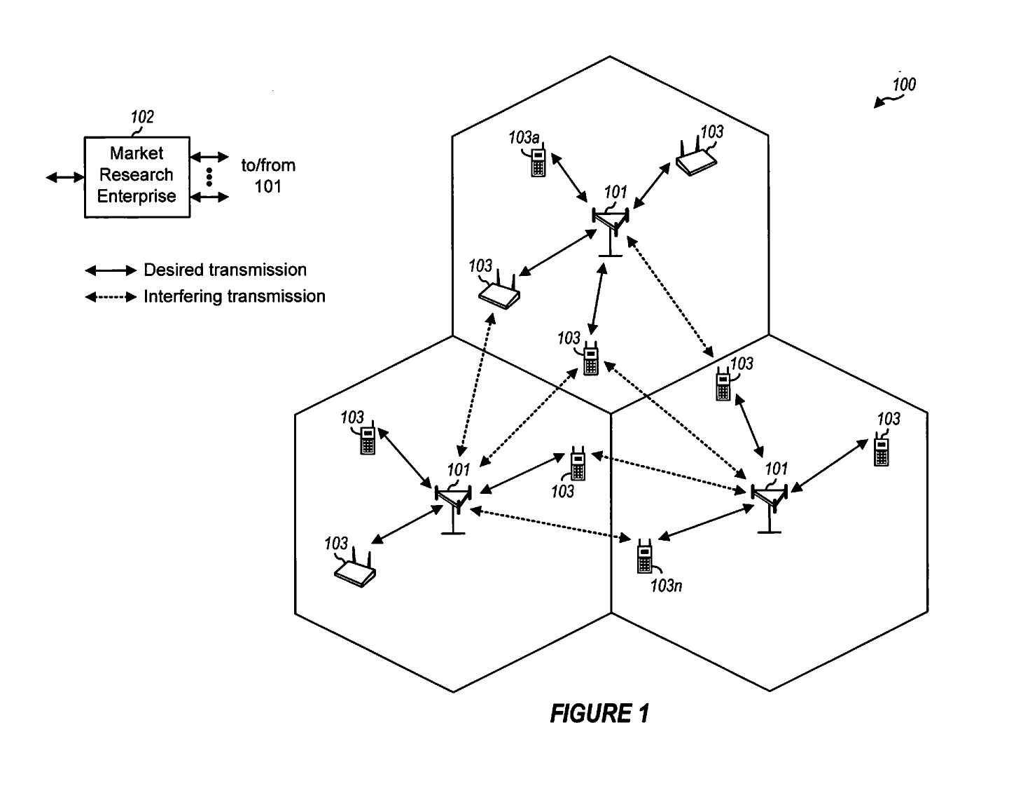

FIG. 1 illustrates network 100 in which concepts described herein may be implemented. Middleware system 101 is in communication with market research enterprise 102 and a plurality of mobile devices 103a-103n. Middleware system 101 is shown as a distributed network, having a plurality of base stations/eNodeBs that coordinate with one another to perform operations described herein. However, it will be understood by those of skill in the art that all or portions of middleware system 101 will comprise a centralized location (perhaps one of a base station/eNodeB, a controller, or enterprise) to enable the operations. As will be further described, middleware system 101 communicates with market research enterprise 102 and mobile devices 103 to enable market research for mobile respondents who come within a proximity of one or more locations of interest. According to one embodiment, middleware 101 and/or market research enterprise 102 may be a market research enterprise that focuses on conducting market research on respondents.

Network 100 may be implemented using a number of wireless communication methods between middleware system 101 and mobile devices 103 and wireless and/or wireline communication methods between middleware system 101 and market research enterprise 102. Such wireless methods include CDMA, TDMA, FDMA, OFDMA, SC-FDMA. A CDMA network may implement a radio technology, such as Universal Terrestrial Radio Access (UTRA), Telecommunications Industry Association's (TIA's) CDMA2000®, and the like. The UTRA technology includes Wideband CDMA (WCDMA) and other variants of CDMA. The CDMA2000® technology includes the IS-2000, IS-95 and IS-856 standards from the Electronics Industry Alliance (EIA) and TIA. A TDMA network may implement a radio technology, such as Global System for Mobile Communications (GSM). An OFDMA network may implement a radio technology, such as Evolved UTRA (E-UTRA), Ultra Mobile Broadband (UMB), IEEE 802.11 (Wi-Fi), IEEE 802.16 (WiMAX), IEEE 802.20, Flash-OFDMA, and the like. The UTRA and E-UTRA technologies are part of Universal Mobile Telecommunication System (UMTS). 3GPP Long Term Evolution (LTE) and LTE-Advanced (LTE-A) are newer releases of the UMTS that use E-UTRA. UTRA, E-UTRA, UMTS, LTE, LTE-A and GSM are described in documents from an organization called the “3rd Generation Partnership Project” (3GPP). CDMA2000® and UMB are described in documents from an organization called the “3rd Generation Partnership Project 2” (3GPP2). The techniques described herein may be used for the wireless networks and radio access technologies described above, as well as other wireless networks and radio access technologies. According to a preferred embodiment, middleware system 101 communicates with market research enterprise 102 and/or mobile devices 103 using LTE or LTE-A wireless communication methods.

While middleware system 101 is illustrated as separate from market research enterprise 102, it should be appreciated that, in some embodiments, middleware system 101 and market research enterprise 102 may be collocated and operate under the direction of shared hardware and software.

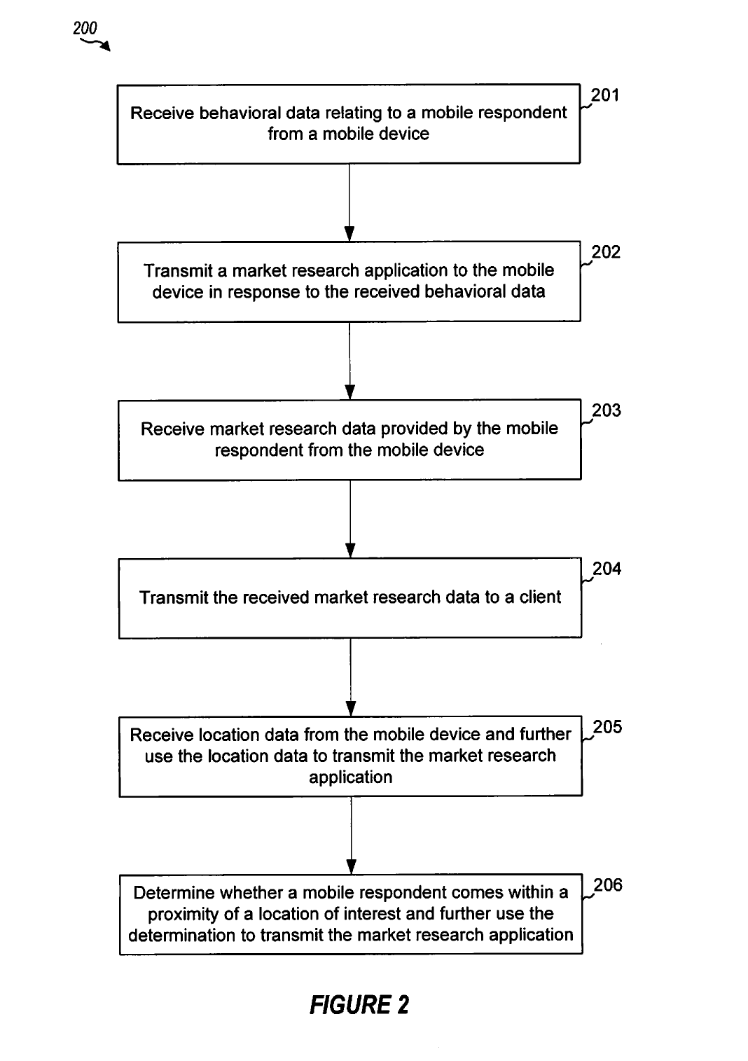

FIG. 2 illustrates functional blocks executed to perform a method of mobile respondent market research according to the concepts described herein. Specifically, FIG. 2 illustrates functional blocks executed by a middleware system such as middleware system 101 illustrated at FIG. 1.

At block 201 behavioral data relating to a mobile respondent is received from a mobile device. According to the concepts described herein, the behavioral data may include various attributes that reflect a respondent's activities, preferences, and/or experiences. As such, the behavioral data may include text message activity, cellular phone activity, web browsing, email activity, and the like. The behavioral data may also include comparisons between activities to determine, e.g., what percentage of time a mobile respondent engages in one form of communication over another. In this way, a market research enterprise may predict a respondent's preferred mode of communication and transmit a market research application according to that mode. Other data may reflect other behaviors useful to a market research enterprise. According to one embodiment, behavioral data may include not only the identity of applications installed on a respondent's mobile device, but the frequency at which those applications are used by the respondent. In this way, the market research enterprise can discern respondent preferences and tailor the subject matter of market research applications directed to the respondent according to those preferences. Behavioral data may also reflect the respondent's past activities or experiences. As such, behavioral data may have a component relating to the respondent's previous locations. Such data provides a market research enterprise with insight as to how a respondent spends different portions of his/her time. This information may be used to predict what type of market research applications are most relevant to a mobile respondent. The more relevant a market research application, the more likely a respondent will provide meaningful market research data.

Further, the behavioral data may be received according to different mechanisms. The behavioral data may be received at determined time intervals, which may be set according to system parameters, respondent preferences, a particular market research application, and the like. These intervals may change according to any number of such parameters. Also, the behavioral data may be received upon the occurrence of an event or condition. For example, the behavioral data may be received when a respondent travels to a certain location, launches an application (e.g., when a respondent launches a mobile research application installed on his/her mobile device), powers or reboots his/her mobile device, and the like. The behavioral data may be collected at the mobile device in a number of ways. According to one embodiment, the functionalities described herein are provided by a market research application installed on the respondent's mobile device. Such an application may collect behavioral data on a continuous or incremental basis, running as a background application on the respondent's mobile device.

At block 202 a market research application is transmitted to the mobile device in response to the received behavioral data. The mobile research application may comprise surveys with different objectives and may be transmitted according to different formats such as push messages, text messages, SRS messages, emails, and the like to a mobile respondent's mobile device 103. According to the concepts described herein, combinations of types of mobile respondent such as, e.g., location and behavioral data, may be used separately and/or in conjunction with one another transmit market research application to the user device.

At block 203 market research data provided by a mobile respondent is received from the mobile device. The mobile respondent provides the market research data by, e.g., completing the previously-transmitted market research application. As such, the received data may comprise a completed survey, a partially-completed survey, a decline to participate in the survey, a request for additional data or instructions, an error message signifying an unsuccessful survey process (perhaps due to low signal strength of mobile device 103), etc. The received data may be utilized by middleware system 101 in a number of ways and for a number of purposes. Where a declined survey request, an incomplete survey, or an error message is received, middleware system 101 may flag the mobile respondent for follow-up, initiating a subsequent market research application according to a determined time interval.

At block 204 the received market research data is transmitted to a client, such as market research enterprise 102 illustrated at FIG. 1. The received market research data may be correlated with other data to interpret the data where, for example, complete survey data is correlated with stored mobile respondent profile data to understand how respondents of different profiles responded to the survey. In that case the correlated data may be transmitted to market research enterprise 102. Otherwise, raw response data may be compiled and transmitted to market research enterprise 102, where market research enterprise 102 correlates or otherwise filters or interprets the market research data received from the mobile respondents. Of course, where middleware system 101 and market research enterprise 102 are collocated, these functions may be executed on shared hardware and/or software.

At block 205 location data is received from the mobile device. It should be appreciated that location data may received in conjunction with other types of data such as, e.g., behavioral data. The received location data may further be used to transmit the market research application. Middleware system 101 may monitor the location of each mobile device 103 (used by a mobile respondent) via a mechanism similar to that utilized by common cellular networks, where a location of each mobile device 103 is resolved by triangulation techniques and the like by base stations serving the cell in which mobile device 103 currently resides. According to an additional embodiment, middleware system 101 may utilize specific location-based communications transmitted from mobile devices 103. Where mobile devices 103 implement GPS-type functionality, each mobile device 103 may transmit GPS data to middleware system 101 which uses that data to launch a market research application as described herein. It should be appreciated that determining a location of a mobile device 103 using either a network-based method (for example, base station/eNodeB triangulation, network statistics data, etc.) or specific location data transmitted from mobile device 103 is a trade off. Relying upon specific location data transmitted from mobile devices 103 may provide more accurate and more up-to-date data; however, it also requires more power from mobile devices 103, more storage space at middleware system 101, and is computationally intensive.

At block 206 a determination is made whether a mobile respondent comes within a proximity of a location of interest. The determination, which may be made in different temporal respects, may further be used to transmit the market research application. In this way, behavioral data and location data associated with a mobile respondent may be correlated to transmit a highly unique market research application to that respondent. The determination may be made by looking back in time where, for example, one or more sets of mobile respondent location data is examined over a preceding time interval. By way of example, middleware system 101 may review and analyze the location history of mobile respondents for the previous two weeks and determine which mobile respondents were in proximity to a location of interest during that time interval. Also, the determination may be made during or close to real-time, so that middleware system 101 is able to identify which mobile respondents are currently at or near a location of interest. Further, the determination may be predictive where, for example, middleware 101 predicts whether a mobile respondent will move in proximity to a location of interest at a future time. In that case, such a forward-looking determination or prediction may be based on additional data including past behavioral data such as the number of times the mobile respondent previously came in proximity to the location of interest, a likelihood of doing so based on respondent profile data (for example, does the respondent fit a profile of someone who would shop at a business at the location of interest), currently-observed behavior (for example, is the respondent apparently taking a direct path to the location of interest or meandering without a clear direction), and the like.

A location of interest may be defined differently depending on system parameters, client preferences, and the like. According to one example, the location of interest may be defined in terms of “raw” data where the location of interest is defined in terms of coordinates, GPS references, latitude and longitude, and the like. According to another example, the location of interest may defined in terms of characteristics of that location. That is, a location of interest may be defined by a particular business or enterprise at the location. The locations of interest may be stored in terms of one or multiple instances, enabling middleware system 101 to determine when a mobile respondent comes in proximity of, for example, a Wal-Mart, or a number of different coordinates without regard to what, if any, business may be located thereat.

Further, a location of interest may be determined by a market research enterprise, such as market research enterprise 102 or middleware system 101. Where a location of interest is received from a source such as market research enterprise 102, that location of interest may be first generated by market research enterprise 102 as a means to conduct market research for businesses at the location of interest and/or certain segments of respondents within the market. Market research enterprise 102 may wish to conduct market research for all respondents determined to have 1) been to a certain location, and 2) exhibited certain behaviors (e.g., having shopped at a particular business, likely to have purchased a particular product, attended a particular movie, test-driven a particular vehicle, and the like). In such cases, market research enterprise 102 may provide to middleware system 101 locations of interest as particular stores, movie theaters, or car dealerships by name or merely in terms of raw data sufficient to describe their geographic location.

The determination of what proximity causes transmission of the mobile research application may be determined by either of market research enterprise 102 or middleware system 101, and may vary according to different mechanisms, depending on client requirements, a given market research application, system limitations, and the like. For example, some market research applications may be initiated where a mobile respondent has come within a mile of a location of interest, while other applications may be initiated where the mobile respondent has come within 20 feet of a location of interest. Further, the proximity of interest may be provided to middleware system 101 by market research enterprise 102, or generated by middleware system 101 upon a formulation of what proximity of interests are thought to satisfy the objectives of market research enterprise 102.

It should be appreciated that the functions performed with reference to FIG. 2 may be iterative where, e.g., an updated or revised market research application is transmitted to a mobile device based on updated information received from the mobile device. The updated information may comprise new behavioral data, new market research data, and new location data. Through this iterative process, a market research enterprise can incrementally refine its market research applications to provide more relevant applications to respondents.

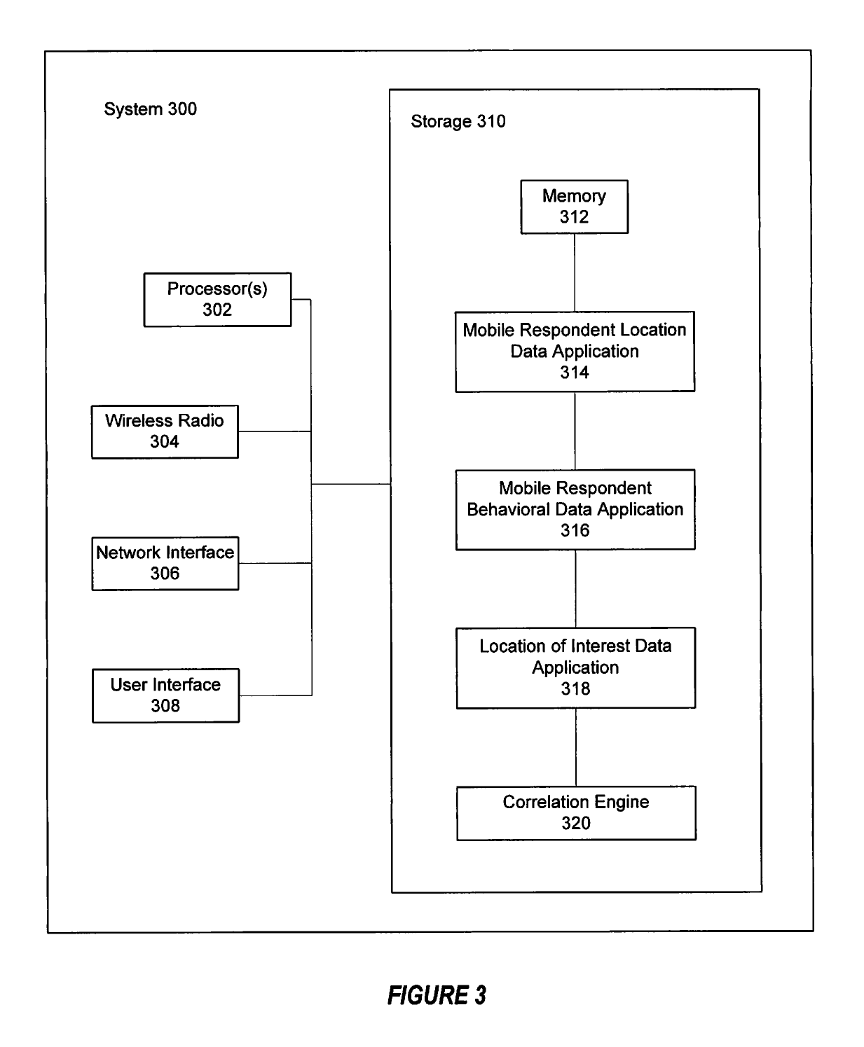

FIG. 3 illustrates a block diagram of components of an apparatus that enables mobile respondent market research according to the concepts described herein. Specifically, FIG. 3 illustrates components of a middleware system such as middleware system 101 illustrated at FIG. 1. Each component may comprise hardware, software, firmware, program code, or other logic (for example, ASIC, FPGA, etc.), as may be operable to provide the functions described herein.

The functionality and operations of client system 300 are controlled and executed through processor(s) 302. Processor(s) 302 may include one or more core processors, central processing units (CPUs), graphical processing units (GPUs), math co-processors, and the like. Processor(s) 302 execute program logic, whether implemented through software stored in memory 312 or in firmware in which logic is integrated directly into integrated circuit components. Client system 300 may communicate wirelessly with multiple client systems and mobile devices through various radios, such as wireless radio 304, such as one or more of wireless wide area network (WWAN) radios and wireless local area network (WLAN) radios. If a WWAN radio is included as one of the radios in wireless radio 304, communication would generally be allowed over a long range wireless communication network such as an LTE network. Client system 300 may also provide communication and network access through a wired connection with network interface 306. The wired connection may connect to the public-switched telephone network (PSTN), or other communication network, in order to connect to the Internet or other accessible communication network.

Client system 300 comprises storage 310, which includes memory 312, mobile respondent location data 314, mobile respondent behavioral data application 316, location of interest data application 318, and correlation engine 320. Under control of processor(s) 302, program logic stored on memory 312, including mobile respondent location data application 314, mobile respondent behavioral data application 316, location of interest data application 318, correlation engine 320, and other applications provides functionality of client system 300, including communications, storage, computation, and filtering, analysis, and correlation of location data, profile data, and location of interest data. Such operating applications may be displayed visually to the user via user interface 308. User interface 308 includes various hardware and software applications that control the rendering of visual data onto the display screen of computers of client system 300 (not shown). User interface 308, under control of the processor(s) 302, controls and operates all forms of interfaces between the user and client system 300. As such, when client system 300 is implemented using a touch screen display, user interface 308 may read the user's input and finger motions on the touch screen and translate those movements or gestures into electronic interface navigational commands and data entry. Various embodiments of user interface 308 also will receive the rendered visual data through processing, controlled by processor(s) 302, and display that visual data on the display. During input to a touch screen device, the user interface 308 may be receiving and analyzing input data from a user's finger movements and gestures on the display screen.

Mobile respondent behavioral data application 316 may configure the processor(s) 302 to extract behavioral data of mobile respondents for various operations described with reference to FIG. 2. In doing so, mobile respondent behavioral data application 316 may execute instructions to analyze the behavioral data and determine what market research applications should be associated with certain behaviors. Further, mobile respondent behavioral data application 316 may serve as an engine to generate market research applications uniquely tailored to the received behavioral data. As such, mobile respondent behavioral data application 316 may receive inputs from various users of middleware system 101, market research enterprise 102, mobile devices 103, respondent data application 314, location of interest data application 318, and correlation engine 320 for use with market research results to correlate and/or filter the data according to specific client requests. Mobile respondent location data application 314 may configure the processor(s) 302 to extract location data of mobile respondents for various operations described with reference to FIG. 2. Additionally, location of interest data application 318 may configure the processor(s) 302 to extract the locations of interest for various operations described with reference to FIG. 2. Correlation engine 320 may be interfaced with mobile respondent location data application 314, mobile respondent behavioral data application 316, and location of interest data application 318, or used with market research results to correlate and/or filter the data according to specific client requests. The correlated data may be used to identify or generate specific market research applications to respondents who exhibit certain behaviors, have visited certain locations in the past, and/or come within a proximity of certain locations of interest.

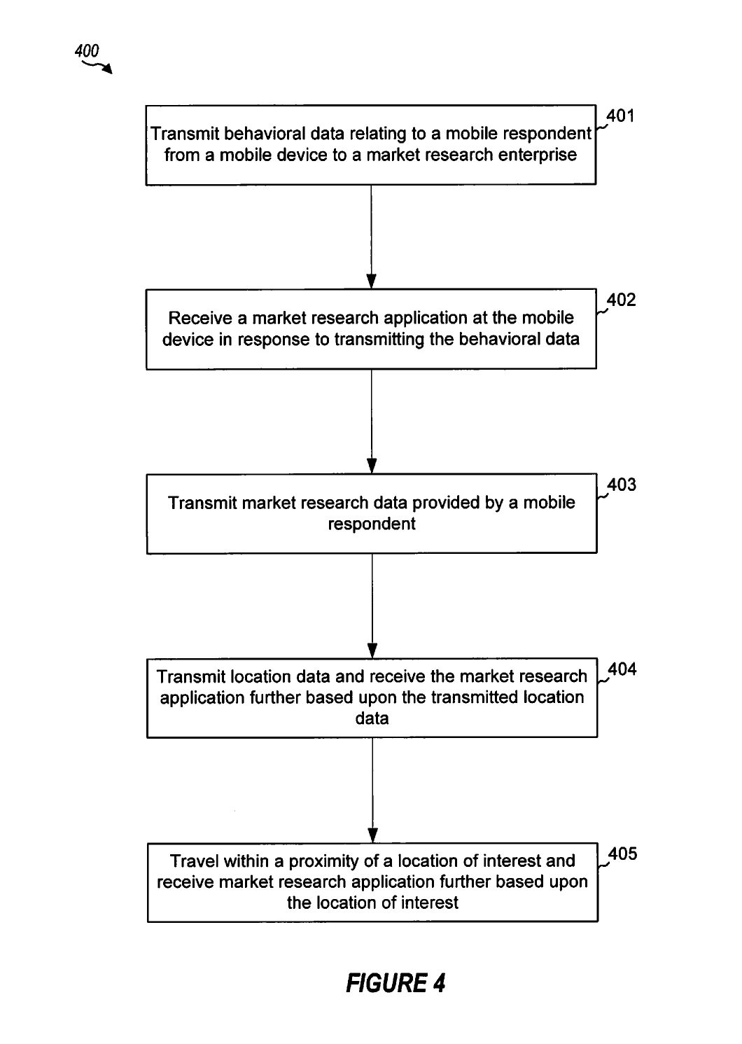

FIG. 4 illustrates functional blocks executed to perform a method of mobile respondent market research according to the concepts described herein. Specifically, FIG. 4 illustrates functional blocks executed by a mobile device such as one or more of mobile devices 103 illustrated at FIG. 1. The functional blocks may be executed at the direction of one or more of hardware, software, and inputs received from a respondent.

According to an embodiment, a user of mobile device 103 may qualify as a mobile respondent in a number of ways. According to one implementation, a mobile user may sign up to receive market research applications relating to a number of activities experienced by that mobile user. Once done, the mobile respondent may download and install an application on their smart phone or laptop or follow specific links received in, e.g., text messages, emails, and the like, to a survey website to participate in a received market research application. As an initial step, the mobile respondent may further provide data used by other systems to extrapolate behavioral data and/or create a profile for that respondent. Such profile data may comprise demographic data, employment and lifestyle data, preference data, respondent preferences, hobbies, general interests, etc.

At block 401 behavioral data relating to a mobile respondent is transmitted from the mobile device to a market research enterprise. Similar to the discussion relating to FIG. 2, the behavioral data may include various attributes that reflect a respondent's activities, preferences, and/or experiences. The behavioral data may include text message activity, cellular phone activity, web browsing, email activity, playing music, camera use, and the identity of applications installed on a respondent's mobile device. The behavioral data may also comprise comparison data such as between the amount of text message activity and cellular phone activity and the frequency at which certain applications are used by the respondent. Further, the behavioral data may have a component relating to the respondent's previous locations.

Further, the behavioral data may be transmitted according to different mechanisms such as according to determined time intervals or upon the occurrence of an event or condition. Also, the behavioral data may be collected at the mobile device in a number of ways. According to one embodiment, the functionalities described herein are provided by a market research application installed on the respondent's mobile device. Such an application may collect behavioral data on a continuous or incremental basis, running as a background application on the respondent's mobile device.

At block 402 a market research application is received at the mobile device in response to transmitting the behavioral data. The mobile research application may comprise surveys with different objectives and may be transmitted according to different formats such as push messages, text messages, SRS messages, emails, and the like to a mobile respondent's mobile device 103.

At block 403 market research data provided by a mobile respondent is transmitted by the mobile device. The mobile respondent provides the market research data by, e.g., completing the previously-received market research application. As such, the transmitted data may comprise a completed survey, a partially-completed survey, a decline to participate in the survey, a request for additional data or instructions, an error message signifying an unsuccessful survey process (perhaps due to low signal strength of mobile device 103), etc.

At block 404 the mobile device transmits data relating to its location to a market research enterprise. In that case, the market research application received by the mobile device may be further based upon the transmitted location data. Similar to the mobile device's transmission of behavioral data, the location data may be transmitted according to different mechanisms such as according to determined time intervals or upon the occurrence of an event or condition. Although, according to one embodiment, location data is typically transmitted at a higher frequency than other types of data such as, e.g., behavioral data. Also, the location data may be collected at the mobile device in a number of ways. According to one embodiment, the functionalities described herein are provided by a market research application installed on the respondent's mobile device. Such an application may collect location data on a continuous or incremental basis, running as a background application on the respondent's mobile device. Also, the location data may be transmitted in various formats such as GPS-based coordinate, latitude and longitude values, and the like. According to another embodiment, network signals such as beacon signals, signals generated during handoff, and requests for service may serve as signal sufficient for a network to determine the location of the mobile device. In that case the mobile device transmits signals sufficient for the network to determine its location (using, for example, base station/eNodeB triangulation, network statistics data, etc.).

At block 405 the mobile device comes within a proximity of a location of interest. In that case, the market research application received by the mobile device may be further based upon the mobile device coming within the proximity of the location of interest. In this way, behavioral data and location data associated with a mobile respondent may be correlated to provide a highly unique market research application to that respondent. The determination may be made by looking back in time where one or more sets of mobile respondent location data is examined over a preceding time interval. Also, the determination may be made during or close to real-time. Further, the determination may be predictive where, for example, the market research enterprise predicts whether a mobile respondent will move in proximity to a location of interest at a future time.

A location of interest may be defined differently depending on system parameters, client preferences, and the like. According to one example, the location of interest may be defined in terms of “raw” data where the location of interest is defined in terms of coordinates, GPS references, latitude and longitude, and the like. According to another example, the location of interest may defined in terms of characteristics of that location. That is, a location of interest may be defined by a particular business or enterprise at the location. The locations of interest may be stored in terms of one or multiple instances, enabling the market research enterprise to determine when a mobile respondent comes in proximity of, for example, a Wal-Mart, or a number of different coordinates without regard to what, if any, business may be located thereat.

The determination of what proximity causes transmission of the mobile research application may be determined by the market research enterprise, and may vary according to different mechanisms, a given market research application, system limitations, and the like. For example, some market research applications may be initiated where a mobile respondent has come within a mile of a location of interest, while other applications may be initiated where the mobile respondent has come within 20 feet of a location of interest.

It should be appreciated that the functions performed with reference to FIG. 4 may be iterative where, e.g., an updated or revised market research application is transmitted to a mobile device based on updated information received from the mobile device. The updated information may comprise new behavioral data, new market research data, and new location data. Through this iterative process, a market research enterprise can incrementally refine its market research applications to provide more relevant applications to respondents.

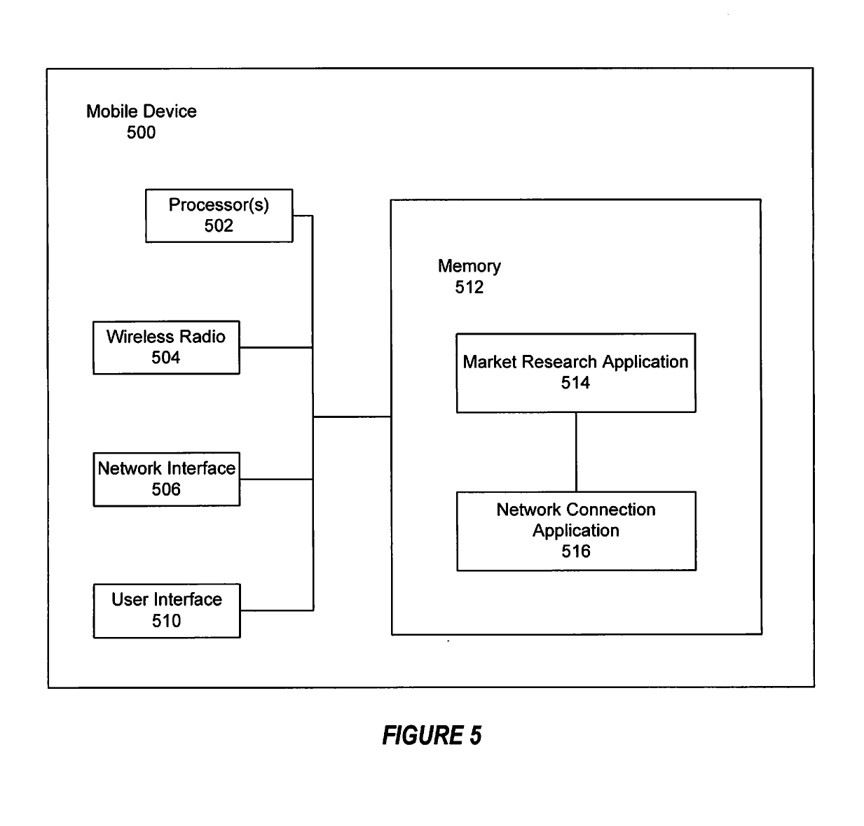

FIG. 5 illustrates a block diagram of components of an apparatus that enables mobile respondent market research according to the concepts described herein. Specifically, FIG. 5 illustrates components of a mobile device such as one or more of mobile devices 103 illustrated at FIG. 1. Each component may comprise hardware, software, firmware, program code, or other logic (for example, ASIC, FPGA, etc.), as may be operable upon or executed to provide the functions described herein. As such, mobile device 500 includes various components common to many typical smart phones, tablet computers, notebook and netbook computers, and the like. Devices, such as mobile device 500 include the processing power, memory, and programming to perform complex tasks, run complex programs, and interact substantially with a user.

The functionality and operations of mobile device 500 are controlled and executed through processor(s) 502. Processor(s) 502 may include one or more core processors, central processing units (CPUs), graphical processing units (GPUs), math co-processors, and the like. Processor(s) 502 execute program logic, whether implemented through software stored in a memory 512 or in firmware in which logic is integrated directly into integrated circuit components. Mobile device 500 may communicate wirelessly through various radios, such as wireless radio 504, such as one or more of wireless wide area network (WWAN) radios and wireless local area network (WLAN) radios, such as WIFI™ radios, BLUETOOTH® radios, and the like. If a WWAN radio is included as one of the radios in wireless radio 504, communication would generally be allowed to communicate over a long range wireless communication network such as 3G, 4G, LTE, and the like. Various WLAN radios, such as WIFI™ radios, BLUETOOTH® radios, and the like, would allow communication over a shorter range. Mobile device 500 may also provide communication and network access through a wired connection with network interface 506. The wired connection may connect to the public-switched telephone network (PSTN), or other communication network, in order to connect to the Internet or other accessible communication network.

Under control of processor(s) 502, program logic stored on memory 512, including market research application 514, and other applications provide functionality of mobile device 500, including communications, Internet access, and execution of various programs for productivity, entertainment, and the like. Applications stored in memory 512 may, when executed by processor(s) 502, operate calendar programs, game programs, list programs, social media programs, web browsers, and the like. Such operating applications are displayed visually to the user via user interface 510. The user interface 510 includes various hardware and software applications that control the rendering of visual data onto the display screen of the mobile device (not shown). The user interface 510, under control of the processor(s) 502, controls and operates all forms of interfaces between the user and mobile device 500. As such, when mobile device 500 is implemented using a touch screen display, user interface 510 may read the user's input and finger motions on the touch screen and translates those movements or gestures into electronic interface navigational commands and data entry. Various aspects of user interface 510 also will receive the rendered visual data through processing, controlled by processor(s) 502, and display that visual data on the display. During input to a touch screen device, the user interface 510 may be receiving and analyzing input data from a user's finger movements and gestures on the display screen. It may also be receiving data from the processor(s) 502 in the form of processed visual or sound data to be output by display to the user, some of which may be to reflect movement of screen objects in response to the user's finger movements.

Market research application 514 may configure the processor(s) 502 to extract a received market research application, whether the market research application is launched within the application itself or launched by a respondent following a link found on a webpage, text message, or email, etc. In operation, the processor(s) 502 may launch market research application 514 in response to the respondent selection to initiate the market research application and provide market research data in response thereto. In some of these embodiments, the processor(s) 502 may employ the user interface 510 to receive respondent input to market data and establish a connection with other systems to transmit that data. Market research application 514 may be further configured to transmit mobile respondent behavioral data at predetermined intervals, which may dynamically change according to concepts described herein. Further, market research application 514 may extract behavioral data from mobile device 500 according to described concepts. Network connection application 516, which may reside in market research application 514, configures the processor(s) 502 to establish a connection for mobile device 500 to transmit market research data, location data, and behavioral data in a manner that will be readily appreciated by one skilled in the art.

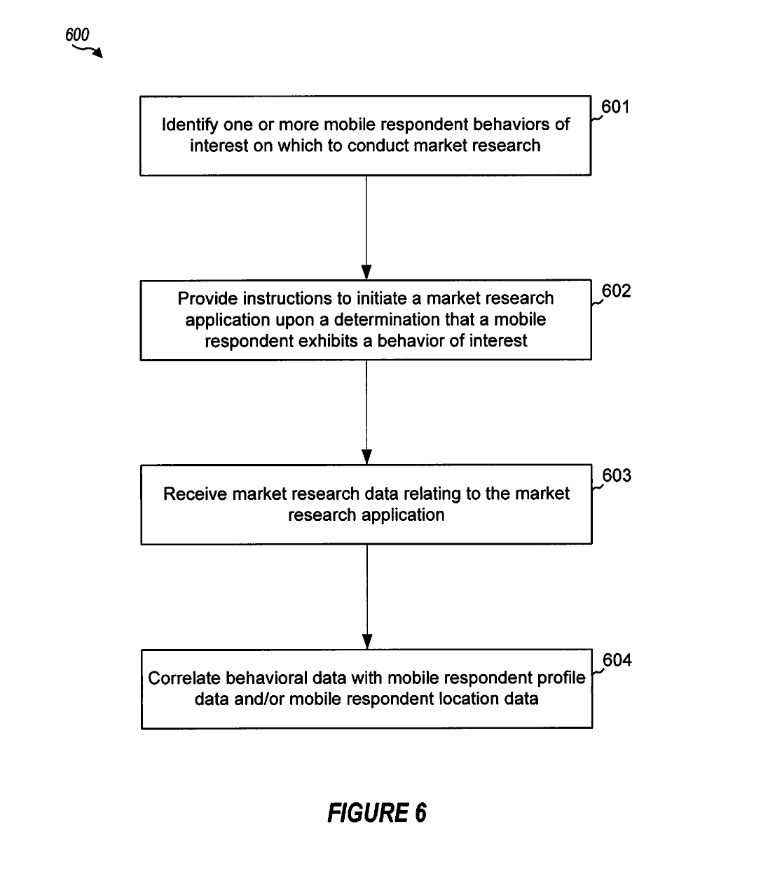

FIG. 6 illustrates functional blocks executed to perform a method of mobile respondent market research according to the concepts described herein. Specifically, FIG. 6 illustrates functional blocks executed by a client system such as market research enterprise 102 illustrated at FIG. 1. The functional blocks may be executed at the direction of one or more of hardware, software, and inputs received from a respondent.

At block 601 one or more mobile respondent behaviors of interest on which to conduct market research are identified. Behaviors of interest may be identified by a market research enterprise according to a number of parameters. The market research enterprise may select a given market research application to only be initiated with respondents that exhibit certain behaviors. On the other hand, the market research enterprise may examine behavioral data to customize a market research application for respondents exhibiting certain behaviors. For example, a vehicle manufacturer may want to identify mobile respondents who visit web pages associated with a particular manufacturer; a music retail store may want to identify respondents that listen to a particular genre of music; while a web developer may want to identify which web sites attract the most page views from a set of respondents.

At block 602 instructions to initiate a market research application upon a determination that a mobile respondent exhibits said behavior of interest are provided. The determination may be made in different ways. According to one embodiment, these types of behaviors may be captured by an application or other piece of software installed on the mobile respondent's mobile device. Such an application or software may collect behavioral data on a continuous or incremental basis, running as a background application on the respondent's mobile device. Once captured, the behavioral data may be transmitted to the market research enterprise according to different mechanisms such as according to determined time intervals or upon the occurrence of an event or condition.

At block 603 market research data relating to said market research application is received. The received market research data may have been previously correlated with mobile respondent profile data and/or mobile respondent location data, where the correlation was performed by middleware system 101. Otherwise, the data may be in a raw format. The received data may comprise a completed survey, a partially-completed survey, a decline to participate in the survey, a request for additional data or instructions, an error message signifying an unsuccessful survey process (perhaps due to low signal strength of mobile device 103), etc. The received data may be utilized by market research enterprise 102 in a number of ways and for a number of purposes. Where a declined survey request, an incomplete survey, or an error message is received, market research enterprise 102 may flag the mobile respondent for follow-up, initiating a subsequent market research application according to a determined time interval. Further the received data may be correlated with other data to interpret the data where, for example, complete survey data is correlated with stored mobile respondent profile data and/or location data to understand how respondents of different profiles, exhibiting different behaviors, and visiting certain locations responded to the survey or other application.

Otherwise, if not already performed, at block 604 behavioral data is correlated with mobile respondent profile data and/or mobile respondent location data. In that case, the correlation is performed by market research enterprise 102. Correlation may be performed to provide better understanding of the market research data and/or to further refine subsequent market research applications to be transmitted to a mobile respondent. In that case, market research enterprise 102 may refine its market research applications by utilizing data collected during or in response to a first market research application and/or the previously described respondent profile data, to transmit a second market research application to the respondent.

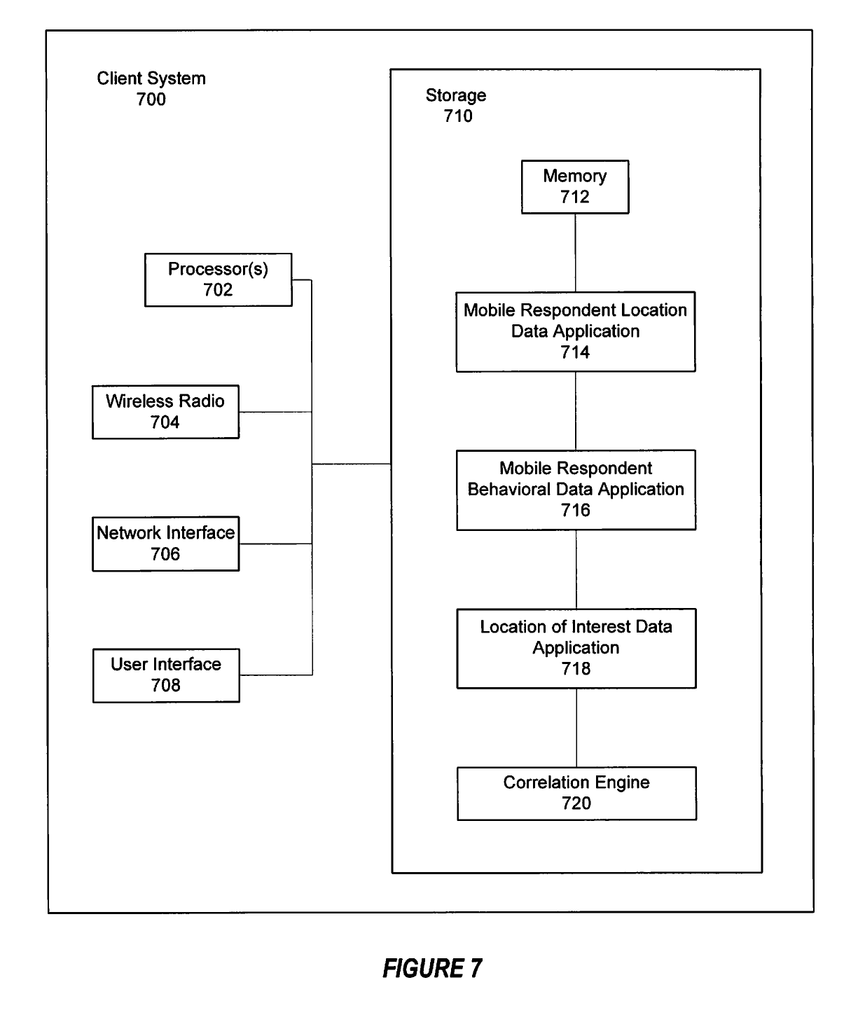

FIG. 7 illustrates a block diagram of components of an apparatus that enables mobile respondent market research according to the concepts described herein. Specifically, FIG. 7 illustrates components of a client system such as market research enterprise 102 illustrated at FIG. 1. Each component may comprise hardware, software, firmware, program code, or other logic (for example, ASIC, FPGA, etc.), as may be operable upon or executed to provide the functions described herein.

The functionality and operations of client system 700 are controlled and executed through processor(s) 702. Processor(s) 702 may include one or more core processors, central processing units (CPUs), graphical processing units (GPUs), math co-processors, and the like. Processor(s) 702 execute program logic, whether implemented through software stored in a memory 712 or in firmware in which logic is integrated directly into integrated circuit components. Client system 700 may communicate wirelessly with multiple client systems and mobile devices through various radios, such as wireless radio 704, such as one or more of wireless wide area network (WWAN) radios and wireless local area network (WLAN) radios. If a WWAN radio is included as one of the radios in wireless radio 704, communication would generally be allowed over a long range wireless communication network such as an LTE network. Client system 700 may also provide communication and network access through a wired connection with network interface 706. The wired connection may connect to the public-switched telephone network (PSTN), or other communication network, in order to connect to the Internet or other accessible communication network.

Client system 700 comprises storage 710, which includes memory 712, mobile respondent location data 714, mobile respondent behavioral data application 716, location of interest data application 718, and correlation engine 720. Under control of processor(s) 702, program logic stored on memory 712, including mobile respondent location data application 714, mobile respondent behavioral data application 716, location of interest data application 718, and correlation engine 720, and other applications provides functionality of client system 700, including communications, storage, computation, and filtering, analysis, and correlation of location data, profile data, and location of interest data. Such operating applications may be displayed visually to the user via user interface 708. User interface 708 includes various hardware and software applications that control the rendering of visual data onto the display screen of computers of client system 700 (not shown). User interface 708, under control of the processor(s) 702, controls and operates all forms of interfaces between the user and client system 700. As such, when client system 700 is implemented using a touch screen display, user interface 708 may read the user's input and finger motions on the touch screen and translate those movements or gestures into electronic interface navigational commands and data entry. Various embodiments of user interface 708 also will receive the rendered visual data through processing, controlled by processor(s) 702, and display that visual data on the display. During input to a touch screen device, the user interface 708 may be receiving and analyzing input data from a user's finger movements and gestures on the display screen.

Mobile respondent behavioral data application 716 may configure the processor(s) 702 to extract behavioral data of mobile respondents for various operations described with reference to FIG. 6. In doing so, mobile respondent behavioral data application 716 may execute instructions to analyze the behavioral data and determine what market research applications should be associated with certain behaviors. Further, mobile respondent behavioral data application 716 may serve as an engine to generate market research applications uniquely tailored to the received behavioral data. As such, mobile respondent behavioral data application 716 may receive inputs from various users of middleware system 101, market research enterprise 102, mobile devices 103, respondent data application 714, location of interest data application 718, and correlation engine 720 for use with market research results to correlate and/or filter the data according to specific client requests. Mobile respondent location data application 714 may configure the processor(s) 702 to extract location data of mobile respondents for various operations described with reference to FIG. 6. Additionally, location of interest data application 718 may configure the processor(s) 702 to extract the locations of interest for various operations described with reference to FIG. 6. Correlation engine 720 may be interfaced with mobile respondent location data application 714, mobile respondent behavioral data application 716, and location of interest data application 718, or used with market research results to correlate and/or filter the data according to specific client requests. The correlated data may be used to identify or generate specific market research applications to respondents who exhibit certain behaviors, have visited certain locations in the past, and/or come within a proximity of certain locations of interest.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks and modules described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method for conducting market research, said method comprising:
receiving, from a mobile device associated with a mobile respondent, behavioral data relating to said mobile respondent; and
transmitting, to said mobile device, a market research application in response to receiving said behavioral data.

2. The method of claim 1 further comprising:
receiving, from said mobile device, market research data provided by said mobile respondent in response to said market research application.

3. The method of claim 2 further comprising:
transmitting data relating to said received market research data to a client system.

4. The method of claim 1 further comprising:
receiving location data from said mobile device; and
wherein transmitting said market research application is further in response to receiving said location data.

5. The method of claim 4 further comprising:
determining whether a mobile respondent comes within a proximity of a location of interest; and
wherein transmitting said market research application is further in response to determining said mobile respondent came within said proximity of said location of interest.

6. The method of claim 1 wherein said behavioral data comprises:
mobile respondent interne activity.

7. The method of claim 1 wherein said behavioral data comprises:
mobile respondent text message activity.

8. The method of claim 1 wherein said behavioral data comprises:
mobile respondent cellular phone activity.

9. The method of claim 1 wherein said behavioral data comprises:
a comparison between mobile respondent text message activity and phone activity.

10. The method of claim 1 wherein said behavioral data comprises:
data relating to applications installed on the mobile respondent's mobile device.

11. The method of claim 1 wherein said behavioral data comprises:
data relating to applications frequently utilized on the mobile respondent's mobile device.

12. The method of claim 1 wherein said behavioral data is received from said mobile device at determined time intervals.

13. The method of claim 1 wherein said behavioral data is received from said mobile device upon the occurrence of an event or condition.

14. The method of claim 1 wherein said behavioral data is passively collected by a market research application installed on said behavioral device.

15. The method of claim 1 further comprising:
receiving, from a mobile device associated with a mobile respondent, a second set of behavioral data relating to said mobile respondent; and
transmitting, to said mobile device, a second market research application in response to receiving said second set of behavioral data.

16. A system configured for market research, said system comprising:
at least one processor; and
a memory coupled to the at least one processor, wherein the at least one processor is configured to:
receive, from a mobile device associated with a mobile respondent, behavioral data relating to said mobile respondent; and
transmit, to said mobile device, a market research application in response to receiving said behavioral data.

17. The system of claim 16 wherein said processor is further configured to:
receive, from said mobile device, market research data provided by said mobile respondent in response to said market research application.

18. The system of claim 17 wherein said processor is further configured to:
transmit data relating to said received market research data to a client system.

19. The system of claim 16 wherein said processor is further configured to:
receive location data from said mobile device; and
transmit said market research application further in response to receiving said location data.

20. The system of claim 19 wherein said processor is further configured to:
determine whether a mobile respondent comes within a proximity of a location of interest; and
transmit said market research application further in response to determining said mobile respondent came within said proximity of said location of interest.

21. The system of claim 16 wherein said behavioral data comprises:
mobile respondent interne activity.

22. The system of claim 16 wherein said behavioral data comprises:
mobile respondent text message activity.

23. The system of claim 16 wherein said behavioral data comprises:
mobile respondent cellular phone activity.

24. The system of claim 16 wherein said behavioral data comprises:
a comparison between mobile respondent text message activity and phone activity.

25. The system of claim 16 wherein said behavioral data comprises:
data relating to applications installed on the mobile respondent's mobile device.

26. The system of claim 16 wherein said behavioral data comprises:
data relating to applications frequently utilized on the mobile respondent's mobile device.

27. The system of claim 16 wherein said processor is further configured to:
receive behavioral data from said mobile device at determined time intervals.

28. The system of claim 16 wherein said processor is further configured to:
receive behavioral data from said mobile device upon the occurrence of an event or condition.

29. The system of claim 16 wherein said behavioral data is passively collected by a market research application installed on said behavioral device.

30. The system of claim 16 wherein said processor is further configured to:
receive, from a mobile device associated with a mobile respondent, a second set of behavioral data relating to said mobile respondent; and
transmit, to said mobile device, a second market research application in response to receiving said second set of behavioral data.

31. A method for conducting market research, said method comprising:
transmitting, from a mobile device associated with a mobile respondent, behavioral data relating to said mobile respondent; and
receiving, at said mobile device, a market research application in response to transmitting said behavioral data.

32. The method of claim 31 further comprising:
transmitting, from said mobile device, market research data provided by said mobile respondent in response to said market research application.

33. The method of claim 31 further comprising:
transmitting location data from said mobile device; and
wherein receiving said market research application is further in response to transmitting said location data.

34. The method of claim 31 further comprising:
coming within a proximity of a location of interest; and
wherein receiving said market research application is further in response to coming within said proximity of said location of interest.

35. The method of claim 31 wherein said behavioral data comprises:
mobile respondent interne activity.

36. The method of claim 31 wherein said behavioral data comprises:
mobile respondent text message activity.

37. The method of claim 31 wherein said behavioral data comprises:
mobile respondent cellular phone activity.

38. The method of claim 31 wherein said behavioral data comprises:
a comparison between mobile respondent text message activity and phone activity.

39. The method of claim 31 wherein said behavioral data comprises:
data relating to applications installed on the mobile respondent's mobile device.

40. The method of claim 31 wherein said behavioral data comprises:
data relating to applications frequently utilized on the mobile respondent's mobile device.

41. The method of claim 31 wherein said behavioral data is transmitted from said mobile device at determined time intervals.

42. The method of claim 31 wherein said behavioral data is transmitted from said mobile device upon the occurrence of an event or condition.

43. The method of claim 31 wherein said behavioral data is passively collected by a market research application installed on said behavioral device.

44. The method of claim 31 further comprising:
transmitting, from a mobile device associated with a mobile respondent, a second set of behavioral data relating to said mobile respondent; and
receiving, at said mobile device, a second market research application in response to transmitting said second set of behavioral data.

45. A system configured for market research, said system comprising:
at least one processor; and
a memory coupled to the at least one processor, wherein the at least one processor is configured to:
transmit, from a mobile device associated with a mobile respondent, behavioral data relating to said mobile respondent; and
receive, at said mobile device, a market research application in response to transmitting said behavioral data.

46. The system of claim 45 wherein said processor is further configured to:
transmit, from said mobile device, market research data provided by said mobile respondent in response to said market research application.

47. The system of claim 45 wherein said processor is further configured to:
transmit location data from said mobile device; and
receive said market research application further in response to transmitting said location data.

48. The system of claim 47 wherein said processor is further configured to:
receive said market research application further in response to coming within said proximity of said location of interest.

49. The system of claim 45 wherein said behavioral data comprises:
mobile respondent interne activity.

50. The system of claim 45 wherein said behavioral data comprises:
mobile respondent text message activity.

51. The system of claim 45 wherein said behavioral data comprises:
mobile respondent cellular phone activity.

52. The system of claim 45 wherein said behavioral data comprises:
a comparison between mobile respondent text message activity and phone activity.

53. The system of claim 45 wherein said behavioral data comprises:
data relating to applications installed on the mobile respondent's mobile device.

54. The system of claim 45 wherein said behavioral data comprises:
data relating to applications frequently utilized on the mobile respondent's mobile device.

55. The system of claim 45 wherein said processor is further configured to:
transmit from said mobile device at determined time intervals.

56. The system of claim 45 wherein said processor is further configured to:
transmit from said mobile device upon the occurrence of an event or condition.

57. The system of claim 45 wherein said behavioral data is passively collected by a market research application installed on said behavioral device.

58. The system of claim 45 wherein said processor is further configured to:
transmit, from a mobile device associated with a mobile respondent, a second set of behavioral data relating to said mobile respondent; and
receive, at said mobile device, a second market research application in response to transmitting said second set of behavioral data.

59. A market research method, said method comprising:
identifying one or more mobile respondent behaviors of interest on which to conduct market research;
providing instructions to initiate a market research application upon a determination that a mobile respondent exhibits said behavior of interest; and
receiving market research data relating to said market research application.

60. The method of claim 59 further comprising correlating said received market research data with mobile respondent location data.

61. The method of claim 59 further comprising correlating said received market research data with mobile respondent profile data.

62. The method of claim 59 wherein said received market research data has been correlated with mobile respondent location data.

63. The method of claim 59 wherein said received market research data has been correlated with mobile respondent profile data.

64. The method of claim 59 wherein said behavior of interest is chosen according to said market research application.

65. A system configured for market research, the system comprising:
at least one processor; and
a memory coupled to the at least one processor, wherein the at least one processor is configured to:
identify one or more mobile respondent behaviors of interest on which to conduct market research;
provide instructions to initiate a market research application upon a determination that a mobile respondent exhibits said behavior of interest; and
receive market research data relating to said market research application.

66. The system of claim 65 wherein said processor is further configured to:
correlate said received market research data with mobile respondent location data.

67. The system of claim 65 wherein said processor is further configured to:
correlate said received market research data with mobile respondent profile data.

68. The system of claim 65 wherein said processor is further configured to:
receive market research data that has been correlated mobile respondent location data.

69. The system of claim 65 wherein said processor is further configured to:
receive market research data that has been correlated with mobile respondent profile data.

70. The system of claim 65 wherein said processor is further configured to:
choose said behavior of interest according to said market research application.
